(19) United States
(12) Patent Application Publication
(10) Pub. No.: US 2011/0304413 A1
(43) Pub. Date: Dec. 15, 2011

(54) HIGH FREQUENCY FILTER

(76) Inventors: Ta-Jen Yen, Hsinchu City (TW); Tsung-Yu Huang, Hsinchu City (TW)

(21) Appl. No.: 12/914,410

(22) Filed: Oct. 28, 2010

(30) Foreign Application Priority Data
Jun. 11, 2010 (TW) TW099118998

(51) Int. Cl. H01P 1/20

(52) U.S. Cl. 333/202

(57) ABSTRACT

A high frequency filter with a wider bandwidth is proposed based on an electromagnetic wave interacted with metamaterial following a left-handed rule and an electromagnetic wave interacted with traditional material following a right-handed rule, and the high frequency filter includes a plurality of filter units arranged in an array and disposed on the same plane, and each filter unit includes a first metal layer, a second metal layer and a dielectric layer, and the first metal layer and the second metal layer are stacked on two opposite sides of the dielectric layer respectively, and the filter is applicable to filtering wave with a frequency of 60 GHz.

### FIELD OF THE INVENTION

The present invention relates to a high frequency filter, and more particularly to a wideband high frequency filter.

### BACKGROUND OF THE INVENTION

Filter is a necessary component for wireless communication products, and its main function is to separate frequencies. In other words, the filter can let a signal with a certain specific frequency pass and block any signal other than those with the specific frequency. As the wireless communication market booms, the requirement of communication quality becomes increasingly higher, and signal receivers require a wideband and high-efficiency filter to process the received high-frequency signal. The high-efficiency filter not only filters unnecessary interference signals, but also provides a wideband utility rate and good receiving efficiency to the high frequency signals.

As the bandwidth becomes wider and wider, data download speed increases significantly, so that researches and applications related to wireless transmission at a band near 60 GHz become more and more important in recent years. With a standard established by the Federal Communications Commission (FCC), any wireless communication at a band near 60 GHz (i.e. 57˜64 GHz) enjoys the right of using free bandwidth about 7 GHz, and thus a wireless HD group formed by international major communication companies including LG, Panasonic, NEC, Samsung, Sony and Toshiba promotes that high resolution video without compression but with resolution up to 1920×1080 p can be wirelessly transmitted at the band of 60 GHz. In high frequency transmission, the band of 60 GHz can thoroughly implement wireless communication and high speed transmission in our daily life.

Various bandpass filters used in conventional commercial Wi-Fi and Bluetooth products are available in the market, and the most popular one among these products is a transmission-line filter, whose single-layer or double-layer metal wire structure can be integrated with other components directly on a printed circuit board. However, this present 60 GHz filter technology still has the issues of having a narrow passband, high loss (approximately 2 dB), and a lower selectivity factor between a passband and a stopband. Furthermore, group hysteresis of the transmission-line filter may cause signal waveform distortion.

### SUMMARY OF THE INVENTION

Therefore, a primary objective of the present invention is to provide a high frequency filter applied in a band of 60 GHz and having a wider passband and a higher selectivity factor between the passband and stopband.

To achieve the foregoing objective, the present invention provides a high frequency filter with a wider bandwidth based on an electromagnetic wave interacted with metamaterial following a left-handed rule and an electromagnetic wave interacted with traditional material following a right-handed rule. The high frequency filter includes a plurality of filter units arranged in an array and disposed on the same plane, and each filter unit includes a first metal layer, a second metal layer and a dielectric layer, and the first metal layer and the second metal layer are stacked on two opposite sides of the dielectric layer respectively.

The high frequency filter of the present invention can be applied in a band of 60 GHz, and the invention not only provides a wider passband, but also provides a higher selectivity factor between the passband and the stopband.

The technical contents of the invention will now be described in more detail hereinafter with reference to the accompanying drawings that show various embodiments of the invention.

### BRIEF DESCRIPTION OF THE DRAWINGS

FIG. 1 is a perspective view of an embodiment of the present invention;

FIG. 2 is an exploded view of the embodiment of the present invention;

FIG. 3 is a schematic view of a filter unit in accordance with the embodiment of the present invention; and

FIG. 4 is a diagram showing relationship between transmittance and frequency of an electromagnetic wave of the present invention.

### DETAILED DESCRIPTION OF THE PREFERRED EMBODIMENTS

The present invention uses the concept of metamaterial to provide a high frequency filter based on both left-handed rule and right-handed rule. Since an electromagnetic wave interacted with metamaterial follows a left-handed rule and an electromagnetic wave interacted with traditional material follows a right-handed rule, the electromagnetic wave can pass through the high frequency filter at a high frequency to produce a wider bandwidth. It is explained that the “high frequency” of the present invention refers to a frequency falling within a range of 1 GHz to 300 GHz instead of the common high frequency defined within a band range of 3 MHz to 30 MHz. The high frequency mentioned in the present invention includes the band range of ultra high frequency (UHF), super high frequency (SHF) and extremely high frequency (EHF). The basic principle of the invention is described briefly as follows:

In general, most materials found in the nature are right-handed materials. When electromagnetic waves pass through the right-handed materials, the directions of electric field and magnetic field, and the phase velocity of electromagnetic waves are perpendicular to each other (or comply with the right hand rule, wherein the thumb indicates the direction of the electric field, and the four fingers indicate the direction of the magnetic field, and the palm indicates the phase velocity of the electromagnetic wave) or the right-hand screw rule. Left-handed materials are opposite to the right-handed materials, wherein an electromagnetic wave passing through a left-handed material has properties opposite to the right-handed material, and the phase velocity of the electromagnetic wave, the directions of the magnetic field and the electric field comply with the left hand rule. The characteristics of the left-handed material can be expressed mathematically as follows. The permittivity ε and the permeability μ of the left-handed material are negative at the same time. According to the formula of the index of refraction: n²=εμ, where the permittivity ε and the permeability μ, are negative at the same time, and the material has a negative index of refraction n.

The propagation of electromagnetic wave in a dielectric material is determined by its permittivity and permeability. Under a normal condition, the dielectric material of the right-handed material has both positive permittivity ε and permeability μ, and thus its index of refraction can be calculated by the aforementioned formula of the index of refraction. Among the materials existed in the nature, the permittivity ε of metal is usually negative, and none of the permeability μ of the metal is negative. From the viewpoint of electromagnetism, during the propagation process of the electromagnetic wave in a medium, atoms and molecules in the medium cannot affect the permittivity and permeability of the electromagnetic wave directly, because the wavelength of the electromagnetic wave is generally much greater than the atom and molecule structures in the medium. Therefore, the atoms and molecules in the medium affect the propagation of electromagnetic wave in an equivalent way. Based on this theory, we can adjust the structure of the medium to fit the electromagnetic wave, such that when the electromagnetic wave passes through the medium, the effect of having a negative permeability μ can be achieved. With the characteristic of a metal having a negative permittivity E, the electromagnetic wave will follow the left-handed rule to change the propagation behavior of the electromagnetic wave when the electromagnetic wave encounters a metal medium. The artificial structure imitating the composition of the nature material is called metamaterial.

The present invention provides a high frequency filter that combines a right-handed dielectric material with the foregoing left-handed metamaterial to form a high frequency filter with a wide bandwidth. The detailed description and technical content of the present invention will be described as follows.

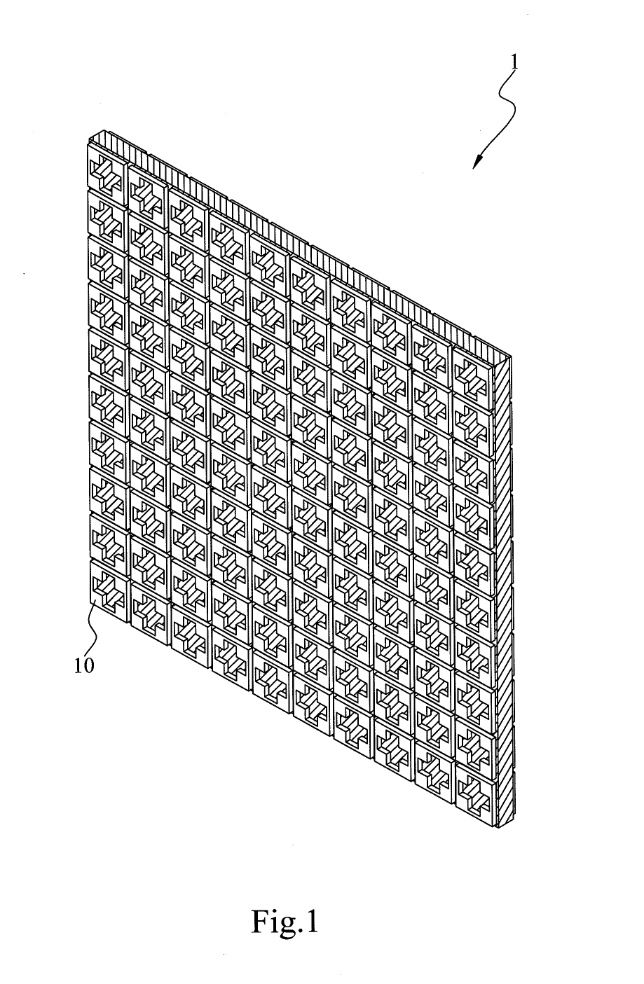

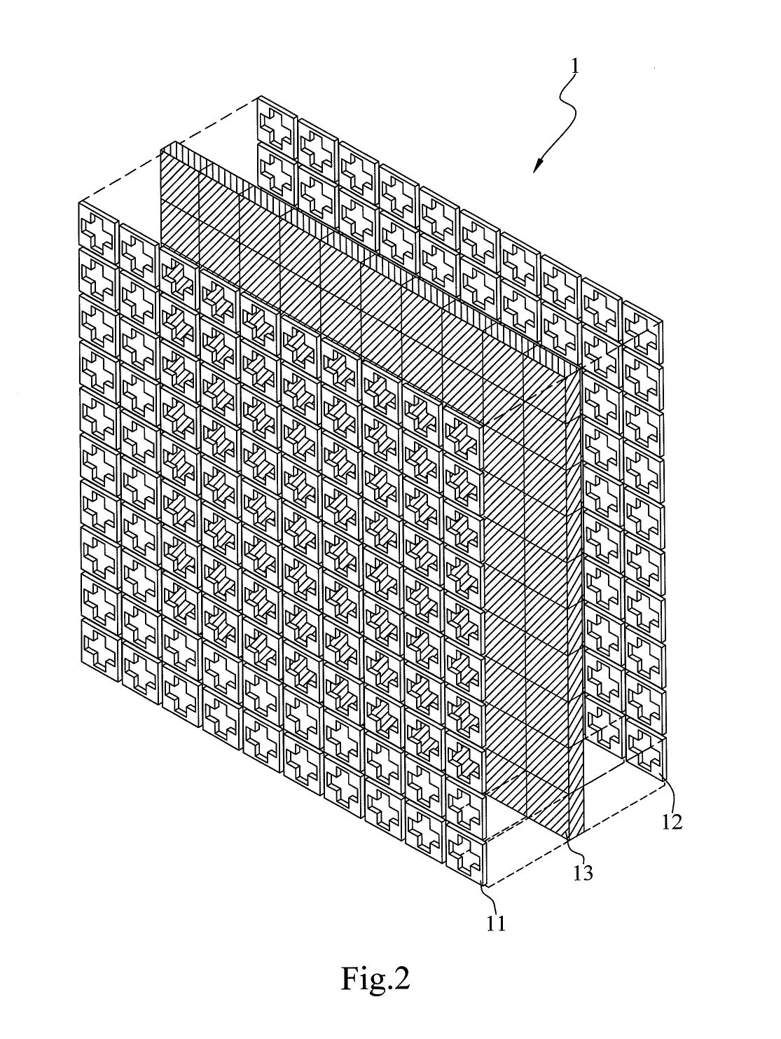

With reference to FIGS. 1 and 2 for a perspective view and an exploded view of a high frequency filter 1 in accordance with an embodiment of the present invention respectively, the high frequency filter 1 comprises a plurality of filter units 10 arranged in an array and disposed on the same plane, and each filter unit 10 comprises a first metal layer 11, a second metal layer 12 and a dielectric layer 13, wherein the first metal layer 11 and the second metal layer 12 are stacked on two opposite sides of the dielectric layer 13 respectively. When the high frequency filter 1 is used for filtering waves, the high frequency filter 1 is preferably disposed in a direction perpendicular to the phase velocity of the electromagnetic wave, such that the electromagnetic wave falling within a passband can pass through the high frequency filter 1 to obtain an accurate filtering effect. The dimension of the high frequency filter 1 should be larger than the desired filtering electromagnetic wave source. It means the dimension of the high frequency filter 1 composed of the filter units 10 should be larger than the range of the desired filtering electromagnetic wave source, so as to prevent the desired filtering electromagnetic wave source from passing through without being blocked by the high frequency filter 1. Therefore, the quantity of filter units 10 in the high frequency filter 1 is not limited, as long as the dimension of the high frequency filter 1 composed of the filter units 10 is larger than the range of the desired filtering electromagnetic wave source. In one embodiment, the first metal layer 11 and the second metal layer 12 are preferably made of a material having better electric conductivity, such as silver (Ag), copper (Cu), gold (Au), and aluminum (Al).

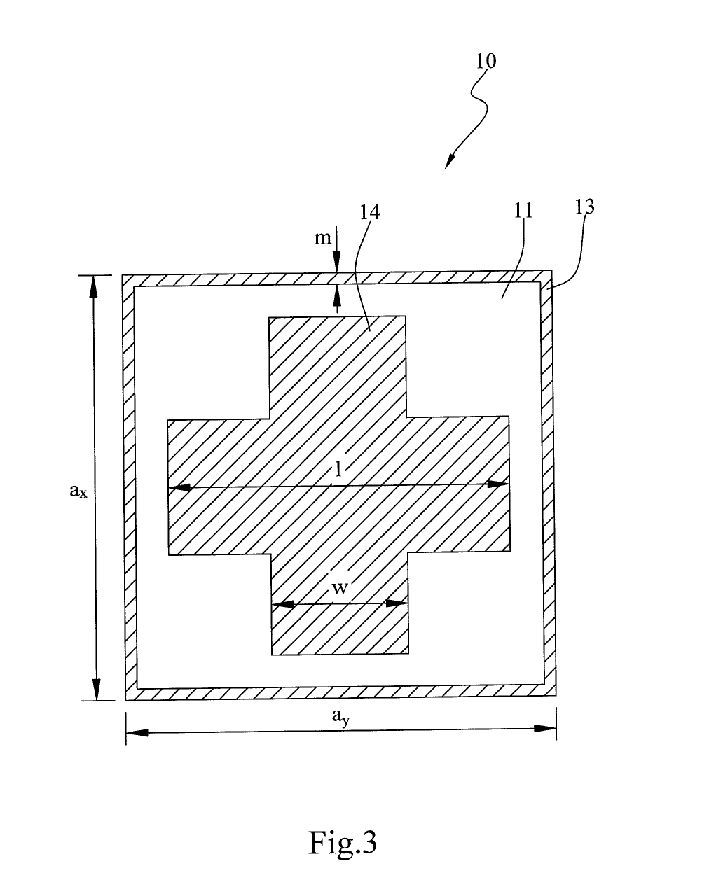

The band of the high frequency filter 1 for filtering waves is determined by the permittivity of the dielectric layer 13 and the dimension of the filter unit 10, and the bandwidth of the passband of the high frequency filter 1 is determined by the union of the passband of a right-handed material and the passband of a left-handed material. As to the right-handed portion, values of both permittivity and permeability of the dielectric layer 13 are positive, thus the right-handed material provides a right-handed passband. As to the left-handed portion, permittivity of the first metal layer 11 and the second metal layer 12 is negative. If the first metal layer 11 and the second metal layer 12 are coupled to two sides of the dielectric layer 13 respectively to form a stacked structure, an equivalent negative permeability is produced to the electromagnetic wave, such that the electromagnetic wave has a left-handed passband, and its principle is described as follows. When the electromagnetic wave encounters the high frequency filter 1, the electromagnetic wave will induce the first metal layer 11 and the second metal layer 12 to generate surface current. The surface current on the first metal layer 11 and the second metal layer 12 flows in opposite directions in a specific electromagnetic wave frequency to form a current loop, and the current loop will sense a new magnetic dipole with reversed direction compared with direction of H-field of incident EM wave. When the first metal layer 11 and the second metal layer 12 generate LC resonance, the intensity of the sensed magnetic dipole is greater than that of the electromagnetic wave, the first metal layer 11 and the second metal layer 12 will produce an equivalent negative permeability to the electromagnetic wave. The filtering properties of aforementioned structure applied to the band of 60 GHz are listed as follows. Firstly, the bandwidth of a passband of the dielectric layer 13 is related to the permittivity of the dielectric layer 13, wherein the cube of the permittivity is inversely proportional to the amplification ratio, and thus different passband frequencies can be obtained by selecting different materials. For example, dielectric Roger board 5580 can be used as the dielectric layer 13 for filtering waves of 60 GHz, and the dimension of the filter unit 10 corresponding to the band of 60 GHz is shown in FIG. 3 and listed in Table 1. It is noted that the dimensions and values given here are provided for illustrating the present invention only, but not intended for limiting the scope of the invention. If the dielectric layer 13 is used for filtering waves of other frequencies, we can simply change the dimension of the filter unit 10 proportionally and select the suitable material for the dielectric layer 13.

A sub-wavelength structure (SWS) composed of the figures of the first metal layer 11 and the second metal layer 12 has dimensions preferably in compliance with an empirical formula that smaller than 0.1 time of the electromagnetic wave wavelength. On the other hand, a hollow area 14 is selectively formed between the first metal layer 11 and the second metal layer 12, and the hollow area 14 and the filter unit 10 form a shape of a 4-fold symmetry, such as a round shape or a cross shape to maintain a better filtering effect of the high frequency filter 1. In FIG. 3, the first metal layer 11 and the second metal layer 12 of the filter unit 10 are formed in a square shape (as shown in FIG. 2), and the hollow area 14 is formed in a cross shape, but the invention is not limited to such arrangement only. When in use, the high frequency filter 1 is disposed in a direction perpendicular to the phase velocity of the electromagnetic wave, so that the direction of the electric field of the electromagnetic wave is parallel to a surface of the high frequency filter 1. The design with a shape of 4-fold symmetry such as the cross shape or the round shape can maintain the high frequency filter 1 to have a similar filtering effect of electromagnetic waves having different directions of the electric fields.

TABLE 1

| Parameter | Value (mm) |
|---|---|
| aₓ | 3 |
| a_{y} | 3 |
| l | 2.5 |
| w | 1 |
| m | 0.01 |

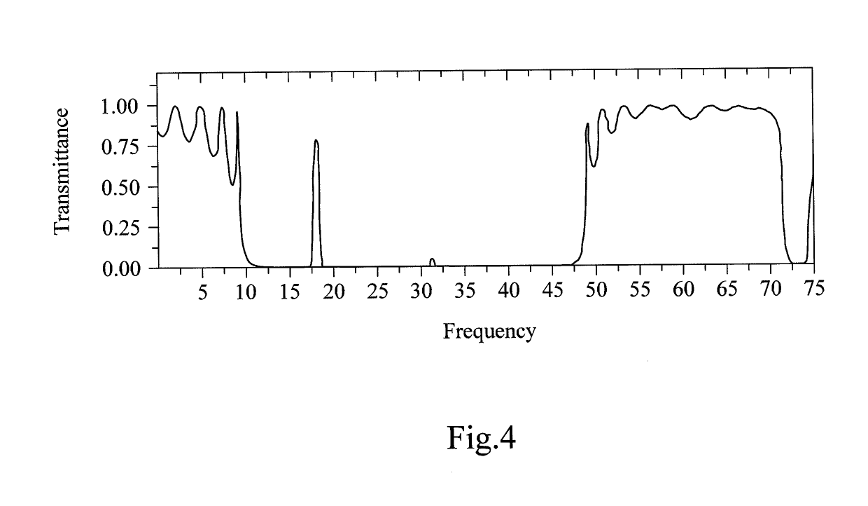

With reference to FIG. 4 for a diagram showing relationship between transmittance and frequency that the high frequency filter 1 is applied, the high frequency filter 1 of the present invention has a very large bandwidth of the passband approximately equal to 20 GHz (50˜70 GHz) at a central frequency of 60 GHz, and the graphs of transmittance of the stopband and the passband are similar to square waves, so that a higher selectivity factor between a passband and a stopband can be achieved. Since the transmission distance of electromagnetic waves in the high frequency filter 1 is approximately equal to the thickness of the filter unit 10 and smaller than the filter range of a conventional transmission-line filter, therefore group hysteresis phenomenon almost will not occur. If the transmission of a 60 GHz signal from a signal source is hindered by a barrier to result in poor receiving efficiency, the frequency will be shifted downward to the WiFi band, and the high frequency filter of the present invention still can filter a low frequency signal, and thus there is no need of installing an additional low frequency filter, so as to minimize the installation of components and reduce the volume of the filter.

In sum of the description above, the present invention improves over the prior art and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A high frequency filter, used for filtering an electromagnetic wave having a center frequency of 60 GHz, and the high frequency filter comprising a plurality of filter units arranged in an array and disposed on a same plane, and each filter unit comprising a first metal layer, a second metal layer, and a dielectric layer, and the first and second metal layers being stacked on two opposite sides of the dielectric layer respectively.

2. The high frequency filter of claim 1, wherein the first metal layer and the second metal layer respectively have a hollow area formed at the center thereof, and the hollow area is formed in a shape of a 4-fold symmetry.

3. The high frequency filter of claim 2, wherein the hollow area is formed in a cross shape.

4. The high frequency filter of claim 2, wherein the hollow area is formed in a round shape.

5. The high frequency filter of claim 1, wherein the filter unit is formed in a square shape.

6. The high frequency filter of claim 1, wherein the first metal layer and the second metal layer are respectively made of a material selected from a group consisting of silver, copper, gold and aluminum.

7. A high frequency filter, comprising a plurality of filter units arranged in an array and disposed on a same plane, and each filter unit comprising a first metal layer, a second metal layer and a dielectric layer, and the first and second metal layers being stacked on two opposite sides of the dielectric layer respectively.

8. The high frequency filter of claim 7, wherein the first metal layer and the second metal layer respectively have a hollow area formed at the center thereof, and the hollow area is formed in a shape of a 4-fold symmetry.

9. The high frequency filter of claim 8, wherein the hollow area is formed in a cross shape.

10. The high frequency filter of claim 8, wherein the hollow area is formed in a round shape.

11. The high frequency filter of claim 7, wherein the filter unit is formed in a square shape.

12. The high frequency filter of claim 7, wherein the first metal layer and the second metal layer are respectively made of a material selected from a group consisting of silver, copper, gold and aluminum.
